(19) United States
(12) Patent Application Publication
(10) Pub. No.: US 2006/0077683 A1
(43) Pub. Date: Apr. 13, 2006

(54) Headlight or light for a motor vehicle

(75) Inventors: Michael Muller, Gifhorn (DE); Frank Ortmann, Gifhorn (DE); Reiner Schellenberg, Gross Schwulper (DE); Malte Mossner, Braunschweig (DE)

Correspondence Address: LERNER GREENBERG STEMER LLP, P O BOX 2480, HOLLYWOOD, FL, 33022-2480, US

(73) Assignee: Volkswagen AG, Wolfsburg (DE)

(21) Appl. No.: 11/286,563

(22) Filed: Nov. 23, 2005

Related U.S. Application Data
(63) Continuation of application No. PCT/EP04/05312, filed on May 18, 2004.

(30) Foreign Application Priority Data
May 23, 2003 (DE) 103 23 321.0
Jan. 29, 2004 (DE) 10 2004 004 398.1

(51) Int. Cl. F21V 29/00

(52) U.S. Cl. 362/544; 362/543; 362/84

(57) ABSTRACT

A headlight or a light for a motor vehicle has at least one illuminant and at least one reflector for reflecting the light generated by the illuminant. The light assembly additionally has an electroluminescent layer.

### CROSS REFERENCE TO RELATED APPLICATION

This is a continuing application, under 35 U.S.C. §120, of copending international application No. PCT/EP 2004/005312, filed May 18, 2004, which designated the United States; this application also claims the priority, under 35 U.S.C. §119, of German patent applications Nos. DE 103 23 321.0, filed May 23, 2003 and DE 10 2004 04 398.1, filed Jan. 29, 2004; the prior applications are herewith incorporated by reference in their entirety.

### BACKGROUND OF THE INVENTION

### Field of the Invention

The invention relates to a headlight or a light for a motor vehicle having at least one illuminating means and at least one reflector for reflecting light that can be generated by means of the illuminating means.

Such a headlight is disclosed, for example, in German published patent applications DE 100 33 766 A1, DE 100 52 653 A1, DE 101 18 687 A1, and DE 198 29 586 A1. Incandescent lamps are used in that case as illuminating means in accordance with DE 100 33 766 A1, DE 100 52 653 A1 and DE 198 29 586 A1. Moreover, the use of gas discharge lamps is disclosed in DE 101 18 687 A1.

Because of the strong influence of the vehicle design on the image of a motor vehicle, motor vehicle headlights are subject today more strongly than ever to design influences. Consequently, corresponding boundary conditions are to be taken into account in designing and configuring headlights for motor vehicles. It is possible on the basis of freeform surface technology in the case of modern vehicle headlights to replace conventionally structured cover panes or lenses by cover panes made from clear glass. However, this also gives rise to the need to fashion the essence of the headlight in accordance with design criteria, as a result of which lighting problems arise in turn, for example so-called self-dazzling of a driver of the motor vehicle caused by deflected light components.

### SUMMARY OF THE INVENTION

It is accordingly an object of the invention to provide a light assembly for a motor vehicle which overcomes the above-mentioned disadvantages of the heretofore-known devices and methods of this general type and which enables the incorporation into a headlight or a light of a motor vehicle of design elements that can, for example, fulfill a function of origin without in the process reducing safety in the operation of a motor vehicle. In particular, it is desirable to enable incorporation of design elements into a headlight or a light of a motor vehicle without the above-named self-dazzling coming about.

With the foregoing and other objects in view there is provided, in accordance with the invention, a light assembly (i.e., a headlight or a light) for a motor vehicle, comprising:

at least one illuminating device for generating light;

at least one reflector disposed to reflect light generated by said illuminating device; and

an electroluminescent layer.

In other words, the above-named objects are achieved by means of a headlight or a light for a motor vehicle having at least one illuminating means and at least one reflector for reflecting light that can be generated by means of the illuminating means, the headlight or the light additionally having an electroluminescent layer. In particular it can advantageously be possible for the electroluminescent layer to be switched on and/or off independently of a high beam, low beam, and/or parking light.

An illuminating device should be understood, in the context of this invention, in particular, as a conventional electric bulb for a headlight or a light for a motor vehicle. An illuminating device for the invention can also be, for example, a halogen lamp, a xenon lamp, or a number of light-emitting diodes, or similar equivalent devices.

In an advantageous refinement of the invention, the electroluminescent layer is connected to the reflector and it is formed, in particular, on the reflector.

In accordance with an advantageous refinement of the invention, the reflector comprises a reflecting layer, the electroluminescent layer being arranged below the reflecting layer. In this case, the reflecting layer is advantageously designed, for example by means of a metal component, as a Venetian mirror that allows light generated by the electroluminescent layer to pass and reflects light generated by the illuminating means. The reflecting layer advantageously consists in this case substantially of an at least partially transparent layer of metal.

In a further advantageous refinement of the invention, the headlight or the light comprises at least one diaphragm, the electroluminescent layer being connected to the diaphragm. The electroluminescent layer is advantageously arranged in this case on the diaphragm.

In a further advantageous refinement of the invention, the headlight or the light comprises a holding device for holding the at least one illuminating means, the electroluminescent layer being connected to the holding device, and the electroluminescent layer advantageously being arranged on the holding device.

In a further advantageous refinement of the invention, the headlight or the light comprises a lens for collecting or scattering the light that can be generated by means of the illuminating means, as well as a lens holder for holding the lens, the electroluminescent layer being connected to the lens holder. In this case, the electroluminescent layer is advantageously arranged on the lens holder.

In a further advantageous refinement of the invention, the electroluminescent layer comprises a layer sequence, at least one of the layers being a layer applied by being sprayed on, sputtering, being spread on, or by means of a screen printing method.

In a further advantageous refinement of the invention, the electroluminescent layer is curved at least in part with a radius of curvature of less than 20 cm, in particular of less than 10 cm.

In a further advantageous refinement of the invention, as a unit the electroluminescent layer covers an area of more than 1 mm². In particular, here the electroluminescent layer is of flat design. Such a refinement is to be preferred to a refinement with a number of point sources such as is disclosed by German published patent application DE 101 33 869 A1 with reference to “white light-emitting diodes” or “white LEDs” of the so-called “quantum well laser” type, “diode laser” type or “quantum point” type, inter alia with reference to Hummel & Guenther, “Thin films for optical coatings,” Vol. 1, C.R.C. Press.

The electroluminescent layer within the meaning of the invention advantageously has a pigment layer that is advantageously arranged between two electrode layers of which at least one is at least partially transparent. In a further advantageous refinement of the invention, the pigment layer contains ZnS, ZnSe and/or ZnS/CdS. The pigment layer advantageously consists of metal-doped ZnS, ZnSe and/or ZnS/CdS.

In a further advantageous refinement of the invention, the headlight or the light comprises a transparent or partially transparent carrier with a visible side, the electroluminescent layer being arranged on a side of the carrier averted from the visible side, that is to say, in particular, below the carrier within the meaning of the invention. The carrier can be, for example, part of a reflector or of a diaphragm. In a further advantageous refinement of the invention, arranged between the carrier and the electroluminescent layer is an at least partially transparent layer consisting substantially of metal.

In a further advantageous refinement of the invention, the metal particularly comprises vapor-deposited aluminum or chromium. The metal advantageously consists substantially of vapor-deposited aluminum.

The motor vehicle within the meaning of the invention is, in particular, a land vehicle that can be used individually in road traffic. Motor vehicles within the meaning of the invention are, in particular, not limited to land vehicles with an internal combustion engine.

Other features which are considered as characteristic for the invention are set forth in the appended claims.

Although the invention is illustrated and described herein as embodied in a headlight or light for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a front view of a motor vehicle;

FIG. 2 shows a side view of a motor vehicle;

FIG. 3 shows a cross section through an exemplary embodiment of a headlight;

FIG. 4 shows a cross section through a further exemplary embodiment of a headlight;

FIG. 5 shows a cross section through a further exemplary embodiment of a headlight;

FIG. 6 shows a cross section through a further exemplary embodiment of a headlight;

FIG. 7 shows a cross section through a further exemplary embodiment of a headlight;

FIG. 8 shows a cross section through an electroluminescent layer, representing an exemplary embodiment of an illuminating layer;

FIG. 9 shows a cross section through a further exemplary embodiment of an illuminating layer;

FIG. 10 shows a cross section through a further exemplary embodiment of an illuminating layer in a headlight; and

FIG. 11 shows a cross section through a further exemplary embodiment of a headlight.

### DESCRIPTION OF THE PREFERRED EMBODIMENTS

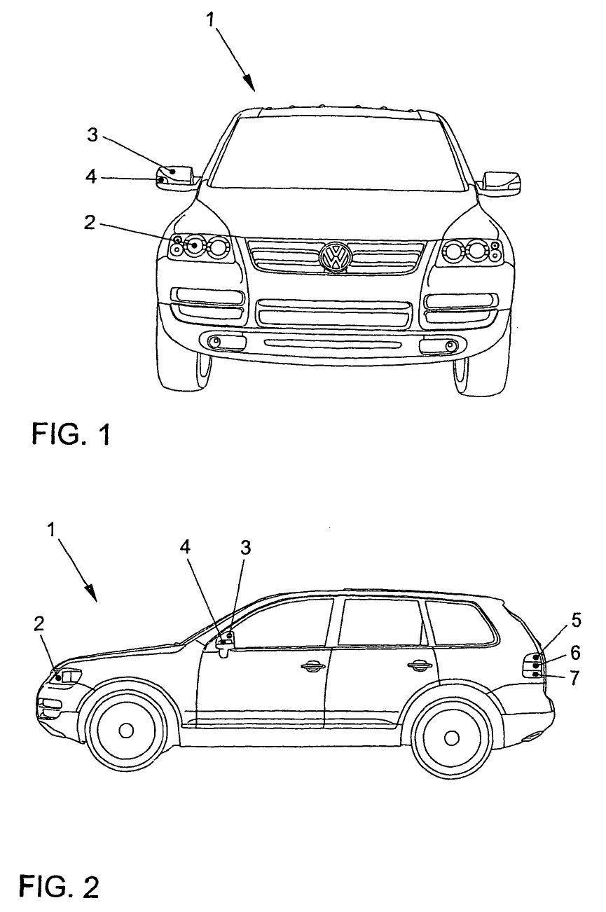

Referring now to the figures of the drawing in detail and first, particularly, to FIG. 1 thereof, there is shown a front view of a motor vehicle 1. Here, reference 2 denotes a headlight, and reference 3 a side mirror with a turn indicator 4. FIG. 2 shows a side view of an exemplary configuration of the motor vehicle 1. At the rear, the motor vehicle 1 has a taillight 5, a brake light 6 and a turn indicator 7.

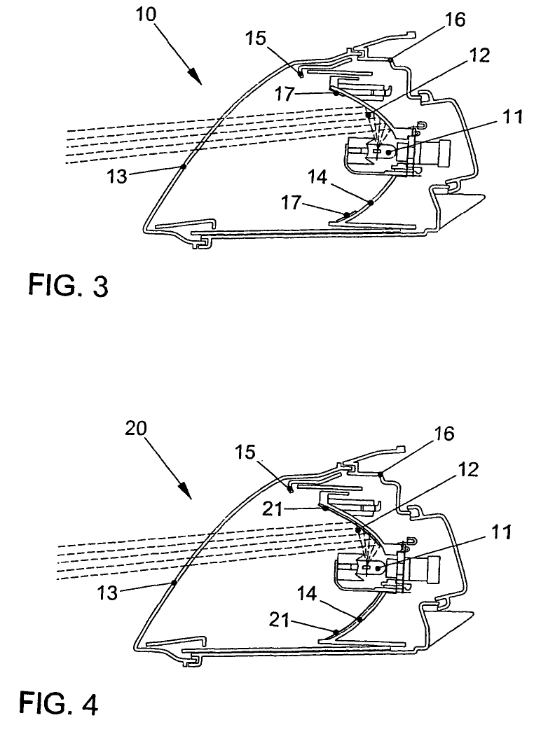

FIG. 3 shows a cross section through an exemplary embodiment of a headlight 10 that can be used as headlight 2 of the motor vehicle 1. The headlight 10 has a housing 16 that is sealed with a cover pane 13. Provided in the housing 16 are an illuminating device or means 11 and a reflector 14 for reflecting light 12 that can be generated by the illuminating device 11. An illuminating layer 17 having an electroluminescent layer is arranged on the reflector 14 at the edge thereof. The headlight 10 has a shutter or diaphragm 15 in the upper region of the reflector 14.

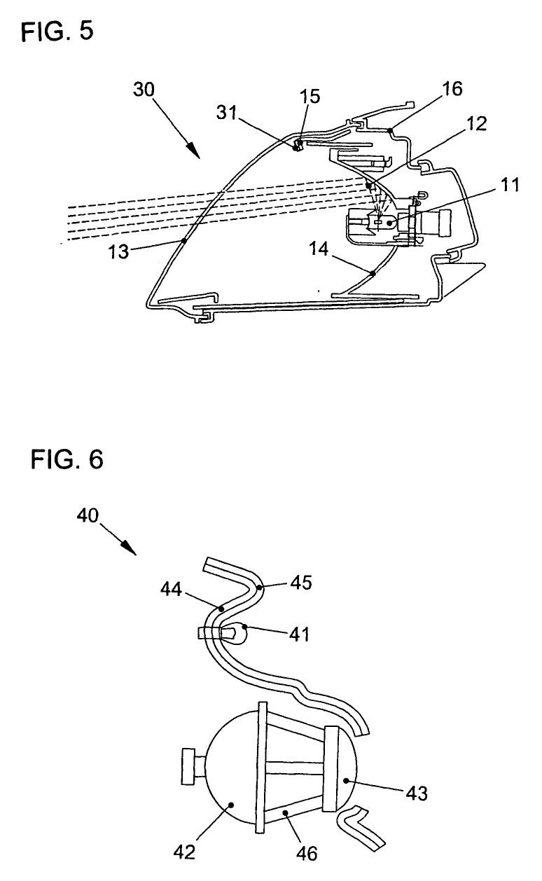

FIG. 4 and FIG. 5 show cross sections through further exemplary embodiments of headlights 20 and 30 that can be used as headlights 2 of the motor vehicle 1. Here, identical reference numerals with elements denote identical elements from FIG. 3. The headlight 20 in accordance with FIG. 4 has an illuminating layer 21 which exhibits an electroluminescent layer and is arranged substantially on the entire reflector 14. The headlight 30 in accordance with FIG. 5 has an illuminating layer 31 which exhibits an electroluminescent layer and is arranged on the diaphragm 15.

It can also be provided that the diaphragms 15 of the headlights 10 and 20 in accordance with FIG. 3 and FIG. 4 exhibit an illuminating layer corresponding to the illuminating layer 31.

FIG. 6 shows a cross section through a further exemplary embodiment of a headlight 40 that can be used as headlight 2 of the motor vehicle 1. The headlight 40 has a holding device 44 wherein an illuminating means 41 is arranged. Also provided in the holding device 44 is a lens holder 46 for holding a lens 43 by means of which it is possible to focus light that can be generated by means of an illuminating means (not illustrated) and can be reflected onto the lens 43 by means of a reflector 42.

Arranged on the holding device 44 is an illuminating layer 45 which exhibits an electroluminescent layer and extends over the entire illustrated region of the holding device 44. It can also be provided to arrange the illuminating layer 45 only in one, for example annular, region about the illuminating means 41 and/or about the lens holder 46 on the holding device 44.

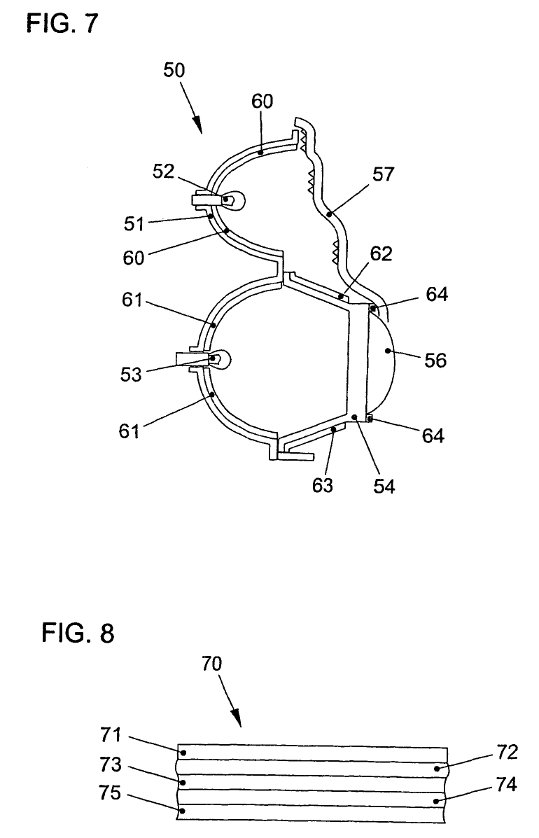

FIG. 7 shows a cross section through a further exemplary embodiment of a headlight 50 that can be used as headlight 2 of the motor vehicle 1. The headlight 50 has a cover pane 57 and a reflector 51 that forms at least a part of a housing. Illuminating means 52 and 53 are arranged in the reflector 51. Arranged in the region of the illuminating means 53 on the reflector 51 is a lens holder 54 for holding a lens 56 by means of which it is possible to focus light that can be generated by means of the illuminating means 53 and can be reflected by means of the reflector 51 onto the lens 56.

Arranged in the region of the illuminating means 52 on the reflector 51 is an illuminating layer 60 that exhibits an electroluminescent layer and extends over the entire curved region about the illuminating means 52. However, it can also be provided to arrange the illuminating layer 60 only in an annular region at the edge of the curved region of the reflector 51 about the illuminating means 52. Arranged in the region of the illuminating means 53 on the reflector 51 is an illuminating layer 61 which exhibits an electroluminescent layer and—in a way similar to the illuminating layer 60—extends over the entire curved region about the illuminating means 53. However, it can also be provided to arrange the illuminating layer 61 only in an annular region at the edge of the curved region of the reflector 51 about the illuminating means 53.

Illuminating layers 62, 63 and 64 which each exhibit an electroluminescent layer are arranged on the lens holder 54. It is possible to provide only a selection or a single one of the illuminating layers 60, 61, 62, 63 and 64 exhibiting an electroluminescent layer.

The illuminating means 11, 41, 52 and 53 can be a conventional electric bulb for a motor vehicle headlight. The illuminating means 11, 41, 52 and 53 can, for example, also be a halogen bulb or a xenon bulb.

FIG. 8 shows a cross section through a possible exemplary embodiment of an electroluminescent layer 70 in accordance with which the illuminating layers 17, 21, 31, 45, 60, 61, 62, 63 and 64 can be configured. The electroluminescent layer 70 has in this case a transparent electrode 71, a transparent insulating layer 72, a light-emitting layer (pigment layer) 73, a further insulating layer 74 and a back electrode 75.

The light-emitting layer (pigment layer) 73 can be formed from a material for which zinc sulfide (ZnS) is used as base material, and to which a small amount of a light-emitting core (Mn) is added. Light is emitted by means of the light-emitting layer (pigment layer) 73 by applying an alternating electric field via the transparent electrode 71 and the back electrode 74, which are connected (in a way not illustrated) to electric contacts (not illustrated) by using an energy source (not illustrated). In order to achieve a luminance of 70 cd/m² or more for the light emission with this electroluminescent layer, the Mn concentration is, for example, approximately 0.4-0.6% by weight (in relation to the zinc sulfide). Such an electroluminescent layer can be produced, for example, by means of a vacuum deposition method, by means of atomic layer crystal growth (ALE), by means of chemical vapor deposition or by means of sputtering. Greater detail on the * exemplary production of such an electroluminescent layer can be gathered from DE 43 32 209 A1.

The pigment layer 73 can also have ZnSe and/or ZnS/CdS, or consist substantially of ZnSe and/or ZnS/CdS. If the pigment layer 73 consists substantially of ZnS, ZnSe and/or ZnS/CdS, this does not rule out the provision of small amounts (in the range of a percentage point) of other elements such as, for example, 0.4-0.6% by weight of Mn, that is to say that the pigment layer 73 is doped with metal, for example.

Further possible configurations of the electroluminescent layers 70 can be gathered from EP 0 699 730 B1.

In the case of a configuration of the illuminating layers 17, 21, 60 and 61 as the above-named electroluminescent layer 70, the further insulating layer 74 and the back electrode 75 are also transparent.

In the exemplary embodiments in accordance with FIG. 3, FIG. 4 and FIG. 7, the electroluminescent layers or the illuminating layers 17, 21, 60 and 61 are arranged on the reflectors 14 and 51. However, it is also possible to provide that the electroluminescent layers 17, 21, 60 and 61 are arranged below a reflecting layer of the reflectors 14 and 51. This has the advantage that reflection properties of the reflectors 14 and 51 are substantially independent of the properties of the electroluminescent layers or the illuminating layers 17, 21, 60 and 61. If it is provided that the electroluminescent layers or the illuminating layers 17, 21, 60 and 61 are arranged below a reflecting layer of the reflectors 14 and 51, the reflecting layer is advantageously configured as a partially transparent layer, in particular as a Venetian mirror, that allows light generated by the electroluminescent layers 17, 21, 60 and 61 to pass, and reflects light generated by the illuminating means 11, 52 and 53.

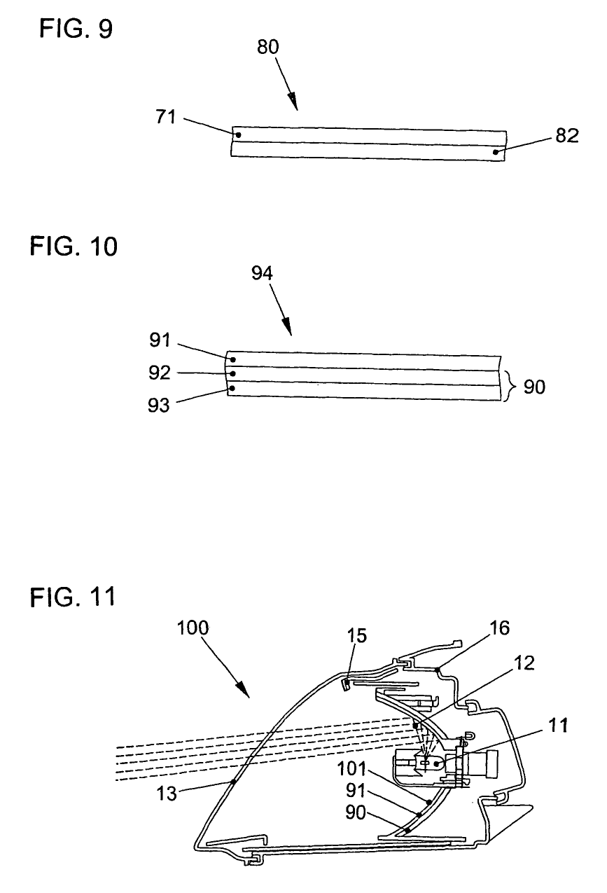

FIG. 9 shows a cross section through a further exemplary embodiment of an illuminating layer 80, in particular for use as illuminating layers 17, 21, 60 and 61, with an electroluminescent layer 82 that can be configured in accordance with the electroluminescent layer 70. In this case, there is arranged on the electroluminescent layer 82 an at least partially transparent layer 81 consisting substantially of metal and is designed as a vapor-deposited aluminum layer, for example. In this case, the layer 81 can correspond to the above-named reflecting layer of the reflectors 14 and 51. It can also be provided that the layer 81 replaces the electrode 71.

FIG. 10 shows a cross section through a further exemplary embodiment of an illuminating layer 90 in a headlight that comprises a transparent or partially transparent carrier 91 with a visible side 94, the illuminating layer 90 being arranged on a side of the carrier 91 averted from the visible side 94, that is to say beneath the carrier 91. The illuminating layer 90 can be configured in accordance with the illuminating layer 80. The illuminating layer 90 has an electroluminescent layer 93 that can be configured in accordance with the electroluminescent layer 70, and an at least partially transparent layer 92 which consists substantially of metal, is arranged on the electroluminescent layer 93 and is designed as a vapor-deposited aluminum layer, for example. It can also be provided that the layer 92 replaces the electrode 71.

The carrier can be part of the reflectors 14, 42 and/or 51, the diaphragm 15, the holding device 44 and/or the lens holder 46 and/or 54. FIG. 11 shows a cross section through a corresponding exemplary embodiment of a headlight 100, the headlight 100 representing an alternative exemplary embodiment of the headlight 4 in accordance with FIG. 4, identical reference numerals with elements from FIG. 3 and FIG. 4 denoting identical elements. Thus, the headlight 100 has a housing 16 that is sealed with a cover pane 13. Provided in the housing 16 are an illuminating means 11 and a reflector 101 for reflecting light 12 that can be generated by means of the illuminating means 11. The headlight 100 has a diaphragm 15 in the upper region of the reflector 101.

The reflector 101 comprises the transparent or partially transparent carrier 91 and the illuminating layer 90, the illuminating layer 90 being arranged beneath the carrier 91. The layer 91 of the illuminating layer 90 consisting, for example, substantially of vapor-deposited aluminum in this case forms a layer for reflecting light 12 that can be generated by means of the illuminating means 11.

The elements and layers in the figures are drawn taking account of simplicity and clarity and not necessarily in a fashion true to scale. Thus, for example, the orders of magnitude of a few elements and layers are illustrated in a fashion clearly exaggerated in relation to other elements and layers, in order to facilitate understanding of the exemplary embodiments of the present invention.

I claim:

1. A light assembly for a motor vehicle, comprising:
at least one illuminating device for generating light;
at least one reflector disposed to reflect light generated by said illuminating device; and
an electroluminescent layer.

2. The light assembly according to claim 1, wherein said electroluminescent layer is connected to said reflector.

3. The light assembly according to claim 2, wherein said electroluminescent layer is formed on said reflector.

4. The light assembly according to claim 2, wherein said reflector is formed with a reflecting layer and said electroluminescent layer is disposed below said reflecting layer.

5. The light assembly according to claim 4, wherein said reflecting layer contains metal.

6. The light assembly according to claim 4, wherein said reflecting layer essentially consists of an at least partially transparent layer of metal.

7. The light assembly according to claim 1 configured as a headlight, which further comprises at least one diaphragm and wherein said electroluminescent layer is connected to said diaphragm.

8. The light assembly according to claim 7, wherein said electroluminescent layer is formed on or below said diaphragm.

9. The light assembly according to claim 1, which further comprises a holding device for holding said illuminating device, and wherein said electroluminescent layer is connected to said holding device.

10. The light assembly according to claim 9, wherein the electroluminescent layer is disposed on or below said holding device.

11. The light assembly according to claim 1, which further comprises a lens for collecting or scattering the light generated by an illuminating means, and a lens holder holding said lens, and wherein said electroluminescent layer is connected to said lens holder.

12. The light assembly according to claim 11, wherein said electroluminescent layer is disposed on or below said lens holder.

13. The light assembly according to claim 1, wherein said electroluminescent layer is formed of layers disposed in a layer sequence, and at least one of said layers is a sprayed-on layer, a sputter layer, a spread-on layer, or a screen printed layer.

14. The light assembly according to claim 1, wherein said electroluminescent layer is curved at least in part with a radius of curvature of less than 20 cm.

15. The light assembly according to claim 14, wherein said electroluminescent layer is curved at least in part with a radius of curvature of less than 10 cm.

16. The light assembly according to claim 1, wherein said electroluminescent layer is disposed in a unit covering an area of more than 1 mm².

17. The light assembly according to claim 1, which further comprises a transparent or partially transparent carrier having a visible side and an opposite side, and wherein said electroluminescent layer is disposed on said opposite said of said carrier.

18. The light assembly according to claim 17, which further comprises an at least partially transparent layer consisting primarily of metal disposed between said carrier and said electroluminescent layer.

19. The light assembly according to claim 18, wherein said reflecting layer comprises aluminum or chromium.

20. The light assembly according to claim 1, wherein said metal comprises aluminum or chromium.

21. The light assembly according to claim 20, wherein said metal comprises vapor-deposited aluminum.

22. The light assembly according to claim 21, wherein said metal consists essentially of vapor-deposited aluminum.

23. The light assembly according to claim 19, wherein said metal comprises vapor-deposited aluminum.

24. The light assembly according to claim 22, wherein said metal consists essentially of vapor-deposited aluminum.

25. In combination with a motor vehicle, the light assembly according to claim 1.

26. The combination with a motor vehicle according to claim 25, wherein said electroluminescent layer is switchable independently of a high beam, a low beam, and a parking light.
